(19) United States
(12) Patent Application Publication
(10) Pub. No.: US 2018/0300807 A1
(43) Pub. Date: Oct. 18, 2018

(54) SYSTEM AND METHODS FOR SAVING FOR EDUCATION RELATED EXPENSES USING ADAPTIVE KNOWLEDGE BASE TO INCENTIVISE POSITIVE CUSTOMER BEHAVIORS AND BUILD CUSTOMER RELATIONSHIPS

(71) Applicant: Lynn A. David, St. Louis, MO (US)

(72) Inventor: Lynn A. David, St. Louis, MO (US)

(21) Appl. No.: 15/953,354

(22) Filed: Apr. 13, 2018

Related U.S. Application Data
(60) Provisional application No. 62/485,364, filed on Apr. 13, 2017.

(51) Int. Cl. G06Q 40/02; G06Q 20/10

(52) U.S. Cl. CPC G06Q 40/02; G06Q 20/10

(57) ABSTRACT

A system and methods for saving for education related expenses and student loan repayment uses an automated adaptive knowledge base to incentivize and reinforce positive customer behaviors to build long-term, multi-generational customer relationships, in combination with special student savings accounts that receive institutional and donor contributions linked to conventional savings and checking accounts for customer deposit transactions. The system and methods of the invention overcome challenges presented by highly secured and regulated financial institution ecosystems and implementation across multiple separate computer systems, and can adaptively learn and influence customer behaviors using tailored customer opportunity and information communications as a function of the learned customer behaviors and profiles.

This application claims the benefit of U.S. Provisional Application No. 62/485,364, filed Apr. 13, 2017.

### TECHNICAL FIELD

The subject disclosure relates to a system and methods for saving for educational expenses that uses an automated adaptive knowledge base to reinforce positive customer behaviors to build long-term, multi-generational customer relationships, using long term, institution derived incentives for saving for education related expenses that builds balances of special education expense payment accounts over time through institutional, donor, and beneficiary customer deposits for dedicated payment of the education related expenses, with fail-safe protections for the institutional donations against contingencies such as customer non-compliance with terms, high interest rates, inflation, etc. The system and methods of the invention are configured to overcome challenges presented by highly secured and regulated financial institution ecosystems and implementation across multiple separate computer systems, and can utilize an adaptive learning marketing system component to generate targeted customer opportunity and information communications as a function of analysis of long term customer profiles and behaviors collected in a customer knowledge base, without infringing privacy.

### BACKGROUND ART

U.S. Provisional Application No. 62/485,364, filed Apr. 13, 2017, is incorporated herein by reference in its entirety.

In 2017, student loan debt in the United Sates is estimated at $1.26 trillion. Approximately 44.2 million borrowers owe student loan debt. In 2016, the average college graduate had $37,172 in student loan debt. In 2012, 71% of students graduating from four-year colleges had student loan debt.

The average student loan delinquency rate in 2017 was 11.1%. This is much higher than the delinquency rate on any other type of consumer loan debt at financial institutions.

In 2017, the average monthly student loan payment for borrowers age 20 to 30 years was reported at approximately $351. The median monthly student loan payment for borrowers age 20 to 30 was reportedly $203. The average is significantly higher than the median because some students pursue advanced degrees and attend private colleges.

In many instances, a student's parents and grandparents are assisting with making the payments on the children's and grandchildren's student loan debt.

Many consumers lack the ability or the discipline to save for educational expenses. One of the primary concerns of parents about their minor children is how to help pay for the children's college or trade school educational expenses. In addition, many parents cannot afford to contribute up to $8,000 per year to a 529 College Savings Plan. Also there is a need to begin saving for education when a child is very young.

After a student graduates from college or a trade school, studies have found that the student has two primary concerns. The first concern is finding a job. The second concern is how to begin to pay their student loan(s).

If junior high and high school age students understand that money is being saved for their college and trade school expenses, it is believed that these students are much more likely to plan to go to college and trade schools.

If the United States has better educated citizens it can change the culture of the United States in a very positive manner. If the United States citizens are more educated, it should result in lower unemployment, a higher standard of living and a lower crime rate.

No known plans or programs currently commercially offered meet the combined needs and desires to encourage education, encourage savings for education, and use financial institution funding to contribute to repayment of student loans and for educational expenses.

Financial institutions, particularly banks, build their relationships with customers based on service, results, perceptions of honesty and trust, and convenience as essential factors.

Account openings and closings are expensive for financial institutions, and thus it is beneficial to establish stable, long-term relationships with customers. Deposit transactions are increasingly automated, reducing opportunities for personal relationship and trust building, and new account and services selling opportunities.

Deposit transactions systems must be secure and confidential, and deriving useful information for marketing purposes has to comply with regulations and customer expectations. Any unsolicited targeted marketing based on confidential banking information and transactions must be carefully orchestrated so as not to be perceived as intrusive or violating customer privacy so as to damage the relationship, trust, etc.

In financial services, having long term relationships with customers, particularly, that span generations, is particularly sought after. Ad hoc contributions of older generation relatives to pay educational expenses and pay down student loan debt are a common occurrence, as mentioned above. However, tax saving programs such as 529 plans mentioned above are often too formal and only involve adult donor funding sources, so there is lack of opportunities for adolescents and students to develop good savings practices. Financial institutions have a desire for customers to succeed and excel, and marketing expenditures are often ineffective and inefficient toward these goals. Also, marketing to different generations is better when the message and approach is customized to the recipient generation.

Thus, what is sought is a set of business procedures and associated systems to encourage education, encourage savings for education and help to pay for educational expenses, and that helps financial institutions build strong, long lasting customer relationships, in a secure, regulatory compliant framework, that overcomes one or more of the shortcomings and problems set forth above.

### SUMMARY OF THE INVENTION

What is disclosed is a set of business procedures and associated systems to encourage education, encourage savings for education and help to repay educational loans and pay educational expenses, and that helps financial institutions build strong, long lasting customer relationships, in a secure, regulatory compliant framework, that overcomes one or more of the shortcomings and problems set forth above.

According to a preferred aspect of the invention, the automated or computerized deposit transaction system of the financial institution will be a component of the system of the invention. The institution will establish, using allocation of institutional funds, an internal debit or other account for funding donations to certain accounts to be established specifically for students or future students, associated with an education savings account in the student or future student's name, herein referred to as “Student Education Savings Account” or “Education Savings Account” for short. This can comprise the depositing of funds in an actual account created in a student or future student's name; creation of an accounting obligation or contingency in the student's name. These accounts are referred to herein as “BankPay Education Savings accounts”, and the funds are earmarked or obligated for disbursement only to a designated student loan lender or lenders, or for designated education related expenses, and only when certain predetermined conditions are satisfied.

According to another preferred aspect of the invention, secure and regulatory compliant rules will be established within the deposit system for how institution funds will be transferred or allocated to, maintained in, and disbursed from, the BankPay Education Savings accounts. These accounts will be individually linked to the Student Education Savings accounts opened by or on behalf of the respective students, which will be set up for deposit of education funds.

Another account in the student's name, for example, a BankPay Checking account, will also be opened and linked to the Education Savings account and BankPay Student Education account.

Additionally, one or more donor accounts will be linked to the Education Savings account. As a result, the student's accounts will be linked to both an institution donor account that will disburse only payments for student loan or educational expenses, and to one or more adult donor accounts from which transfers specifically to the Education Savings account will be made in accordance with set rules. The Education Saving accounts can also receive deposits from other sources, including from outside of the financial institution.

The funds collected in the Education Savings account can be used by the student for any purpose, or can be subject to special rules, and rules can be established for assessment of charges, fees, and the like, with regard to numbers or amounts of withdrawals, low balance, etc. The charges can be retained by the institution or transferred to the Education Savings account. This will acquaint the student to conventional savings account practices.

The BankPay Checking account can be used in the manner of a normal checking account, and typical charges for overdrafts, low balances, etc., can apply and again can be collected all or in part by the institution, or transferred to the benefit of the student to acquaint the student with best checking account holder behaviors and practices.

As incentives for saving, a key component of the system of the invention will be periodic or regular automatic transfers or allocations of institution funds to the BankPay Education Savings account, provided the rules governing the student accounts are met for a particular associated period. The system can be structured so that the institutional funds are allocated to the student, for instance, in a joint account with the institution or an agent or affiliate, but will be non-accessible except for the prescribed student loan and/or educational expense disbursements. So essentially the BankPay Education Savings account is a companion account to the student's own accounts, but cannot be routinely accessed. Claw back provisions can also be established, if permitted by governing regulations, that would allow recovery of the transferred or allocated funds by the institution if student accounts are closed or certain rules are broken, e.g., minimum balance or transfer rules.

Transactions involving deposits, checks, and withdrawals will be handled conventionally, subject to the prescribed rules, within the deposit transaction system of the financial institution.

As another preferred aspect of the invention, an automated accounting system is incorporated into the BankPay system. Account balance data and transactional data for BankPay and student accounts will be regularly communicated from the deposit transaction system of the financial institution to its automated accounting system in a manner compliant with regulations and normal procedures including with regard to security and privacy. The account information is specially coded to identify that it is part of the BankPay system. Data will be compiled with regard to compliance with established rules. The account data and other data can be scrubbed of, and/or disassociated from, individual account holder personal information, to enable determining system metrics and performance to protect privacy, if desired or required.

According to another preferred aspect of the invention, the accounting system will generate management and analyst reports that can be used to determine whether to expand, change, curtail, various aspects of the BankPay system, including amount, timing, etc., of allocations of institutional funds. Macro-wise, for a given year or other period going forward, additional institutional funds may need to be authorized, transferred, allocated, or contingently allocated, to cover predicted outlays, e.g., to accommodate growth of the BankPay system. For instance, allocated funds may experience growth due to fortuitous investing so that the proceeds of only a portion, or all, of the allocated funds growth need be disbursed as payments for loans and student expenses. There may also be various other conditions that can trigger changes, such as high interest rates, inflation, deflation, etc. Program success may dictate growth. Program adjustments can be made using this data. Behavioral analytics can be employed to determine or predict program success or problems, and with student data, market data, etc., can be used to adapt the system for various purposes.

It is recognized that parameters including, but not limited to, starting fund balances, deposits, student or future student age, donor wealth, age, income, health, relationship, for example, marital status, etc., births, deaths, are all subject to change, as are targeted or anticipated student loan amounts, expense amounts, etc. The system of the invention is intended by design to last many years for each individual customer, and even multiple decades. It is therefore a desired and necessary objective of the invention to maintain sufficient communication between the financial institution, student, and donor or donors, so that automatic program adaptations, adjustments, and the like can be made as desired or required to accommodate changing conditions, needs, objectives, etc., including on a continuing and/or periodic basis.

According to another preferred aspect of the invention, an automated marketing system is another component of the system. It will receive lists, data and or reports from the automated deposit and/or accounting systems. For instance, macro- and micro-system health reports relative to milestones, goals, etc., student age, etc. Marketing communications will be automatically generated that are appropriate and targeted both customer-wise and content-wise, e.g., the content being focused for a particular purpose or purposes such as encouraging deposits so as to in turn trigger institutional deposits, to inform of promotions, etc., and sent to the students, donors, adults, etc. Feedback or status communications will be solicited, so that feedback relating to student and/or donor needs, desires, goals, changes in circumstances, or leads for additional services, will be generated. As these are existing customers, this will be more effective than mass mailings, and because the financial institution has been making an ongoing contribution of institution funds to the BankPay Education Savings Account, the student and/or responsible adult will have a vested interest in maintaining contact and ensuring that information is current, including student status in school, educational loan balances, needs, etc. And this presents a marketing, trust, and relationship building opportunity for the institution. The student and/or responsible adult can be invited to personal banker meetings to develop the relationship and tailor the student's BankPay accounts. Services such as check book balancing, budgeting, and the like, can be woven into the customer contacts and personal banking relationship. Student age milestones can be used for generating additional marketing opportunities, e.g., graduation for auto loans, credit cards, etc.; marriage for addition of account holders; divorce; inheritance; windfalls; new accounts, and later milestones for home mortgage loans and the like. Incentives can also be provided for opening new accounts, enrolling for new programs, services, and the like.

After the student has completed his or her education, and loans and other education related expenses are becoming due, and/or being paid, the institution can optionally continue the program with the student now becoming both a recipient and donor. As a result, for former student donations, there can be a matching institutional donation. The student's employer may also become a donor. Addition of accounts for student's children or other beneficiaries is also contemplated, and provisions can be made for transfer of unused balances from the BankPay Education Savings accounts to other beneficiaries. Thus, it can be envisioned that as the student matures and the donor adult(s) phase out, the student or now former student who has successfully paid all education related expenses and paid off his or her student loan will eventually transition to the donor role for the next generation of student or student to be.

A simplified summary is provided as follows to help enable a general understanding of the BankPay Education Savings/Checking business process. This summary is intended to present the basic concepts of the new business process.

### BRIEF DESCRIPTION OF THE DRAWINGS

FIG. 1 is a high level diagrammatic representation of Deposit Transaction System components of the invention, for customers (student or future student) 18 years of age and older, and under that age.

FIG. 1A is an overall diagrammatic representation of components, and data and information flow, of the system and method of the invention.

FIG. 2 illustrates an operational step according to the system and methods of the invention.

FIG. 3 illustrates an operational step according to the system and methods of the invention.

FIG. 4 illustrates an operational step according to the system and methods of the invention.

FIG. 5 illustrates linking between aspects of the system and methods of the invention.

FIG. 6 illustrates operational steps according to the system and methods of the invention.

FIG. 7 illustrates an operational step according to the system and methods of the invention.

FIG. 8 illustrates association of accounts according to the system and methods of the invention.

FIG. 9 illustrates an account of the system and methods of the invention.

FIG. 10 illustrates operational association between accounts according to the system and methods of the invention.

FIG. 11 illustrates a prohibited operational step according to the system and methods of the invention.

FIG. 12 illustrates an operational step according to the system and methods of the invention.

FIG. 13 illustrates an operational step according to the system and methods of the invention.

FIG. 14 illustrates an operational step according to the system and methods of the invention.

FIG. 15 illustrates association of accounts according to the system and methods of the invention.

FIG. 16 illustrates an operational step according to the system and methods of the invention.

FIG. 17 illustrates an operational step according to the system and methods of the invention.

FIG. 18 illustrates a prohibited operational step according to the system and methods of the invention.

FIG. 19 illustrates an operational step according to the system and methods of the invention.

FIG. 20 illustrates an account according to the system and methods of the invention.

FIG. 21 illustrates an operational step according to the system and methods of the invention.

FIG. 22 illustrates an operational aspect according to the system and methods of the invention.

FIG. 23 illustrates an operational step according to the system and methods of the invention.

FIG. 24 illustrates operational steps according to the system and methods of the invention.

FIG. 25 illustrates an operational step according to the system and methods of the invention.

FIG. 26 illustrates an operational step according to the system and methods of the invention.

FIG. 27 illustrates an operational step according to the system and methods of the invention.

FIG. 28 illustrates an operational step according to the system and methods of the invention.

FIG. 29 illustrates an operational step according to the system and methods of the invention.

FIG. 30 illustrates an operational step according to the system and methods of the invention.

FIG. 31 illustrates an operational step according to the system and methods of the invention.

FIG. 32 illustrates an operational step according to the system and methods of the invention.

FIG. 33 illustrates an operational step according to the system and methods of the invention.

FIG. 34 illustrates operational steps according to the system and methods of the invention.

FIG. 35 illustrates operational steps according to the system and methods of the invention.

FIG. 36 illustrates operational steps according to the system and methods of the invention.

FIG. 37 illustrates operational steps according to the system and methods of the invention.

FIG. 38 illustrates an aspect of the system and methods of the invention.

FIG. 39 illustrates operational steps according to the system and methods of the invention.

FIG. 40 illustrates operational steps according to the system and methods of the invention.

FIG. 41 illustrates operational steps according to the system and methods of the invention.

FIG. 42 illustrates operational steps according to the system and methods of the invention.

FIG. 43 illustrates operational steps according to the system and methods of the invention.

### DETAILED DESCRIPTION OF PREFERRED EMBODIMENTS OF THE INVENTION

As discussed in the Background section, conventional savings programs do not help customers save for education expenses. The BankPay Education Savings/Checking system helps to create the discipline on the part of potentially multiple customers to savings for educational expenses of one or more customers while helping the beneficiary customer to develop good savings habits.

### Deposit Transaction System Setup

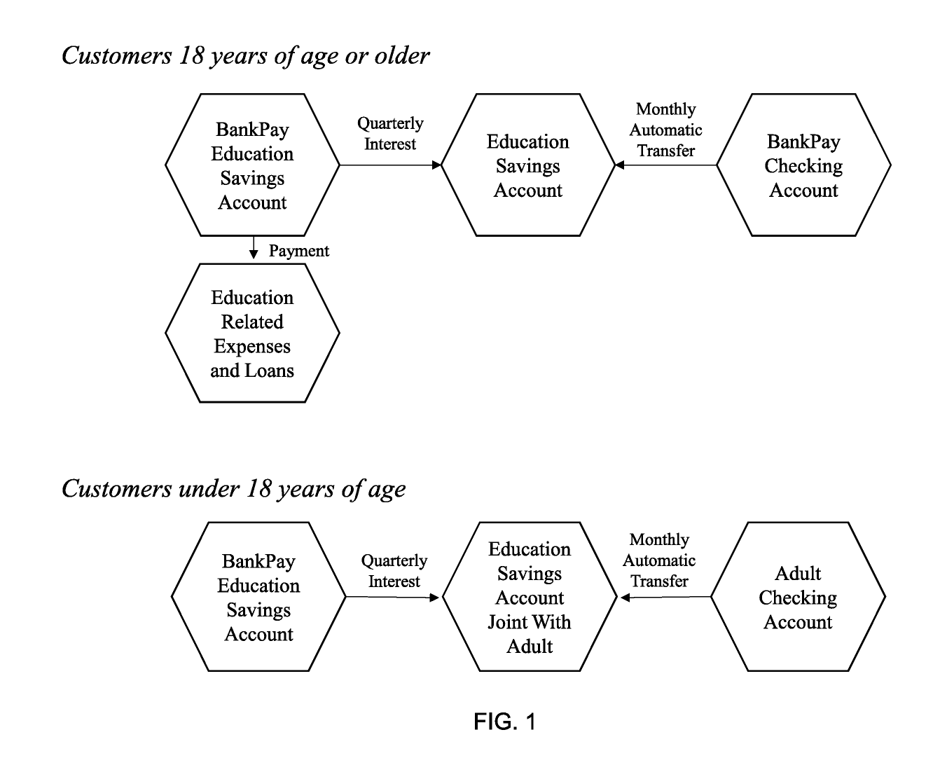

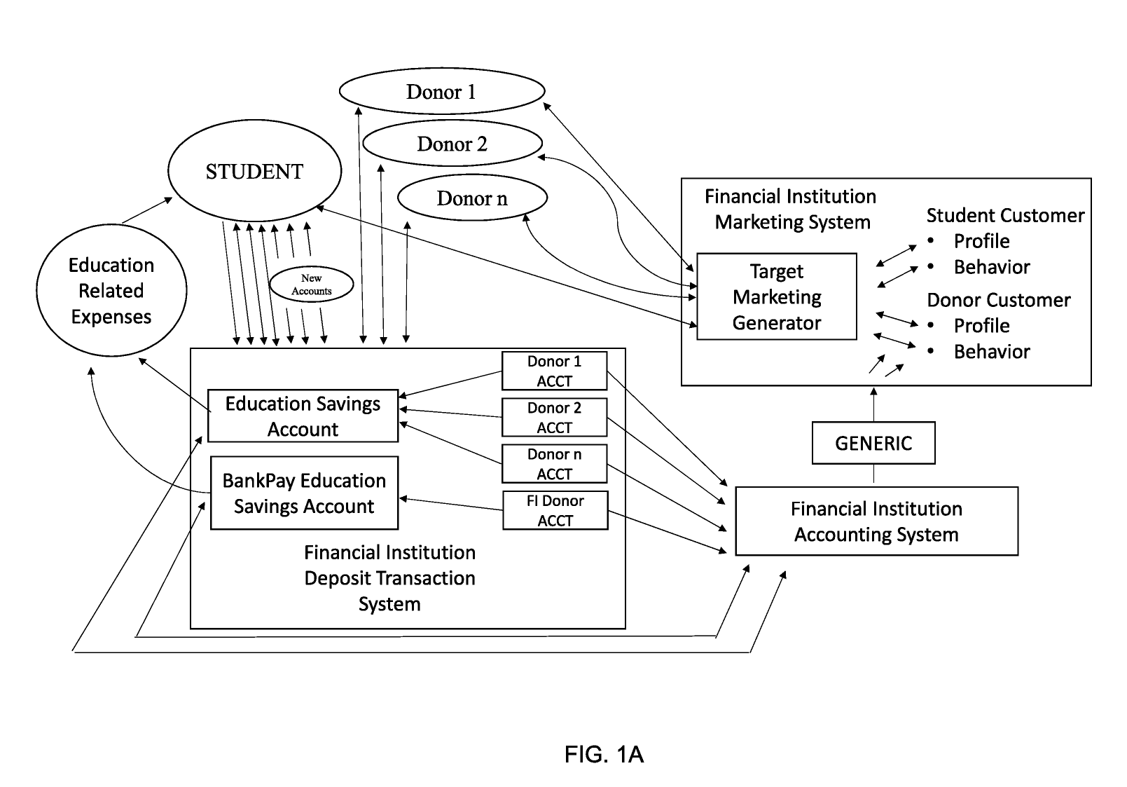

The system accounts can be set up by a “donor” customer, typically an adult, and a student or future student “beneficiary” or “recipient” who will become a customer. So immediately, the bank receives a new customer and has the opportunity to teach good money management and savings skills and habits. Referring to FIG. 1, the financial institution creates a Student Education Savings account product (herein also identified sometimes as Education Savings Account) on the computerized deposit transaction system of the financial institution, to be opened in the student's name (primary account holder). This product will be available to customers of any age with a valid social security number. When the primary account holder is under 18 years of age, the account must be joint with someone 18 years of age or older. The financial institution creates a BankPay Education Savings account in the student's name on the deposit system. And the financial institution creates a BankPay Education Checking account which will be available to any customer 18 years of age or older with a valid social security number. When the primary account holder is under 18 years of age, the account must be joint with someone 18 years of age or older.

Knowledge Base

Referring also to FIG. 1A, as a preferred aspect of the invention, an automated adaptive cognitive knowledge base that will create, compile, and analyze customer profiles and behaviors will be generated with inputs from various sources including periodic or continuous inputs from the deposit system either directly or indirectly through the accounting system. Thus the knowledge base will employ cognitive computing capability as opposed to just pre-programmed data processing capability. This will be hosted in at least one suitable data repository or memory operatively connected to a computer processor. Obviously, initial customer profile and behavior data will be limited, but will build over time with additional inputs. In the absence of actual knowledge for a particular customer, the knowledge base can substitute model profile and behavior characteristics, for instance, from customer interview, questionnaire, or survey information. The automated knowledge base can reside anywhere on the financial institution's computer system, or can be located elsewhere, including externally to the institution's data processing system, provided by a 3^{rd} party, such as a marketing vendor or the like. Steps will be implemented to protect customer deposit data and privacy. As a non-limiting example, it can be observed that arrows representing data and information flow from the deposit transaction system to the accounting system, and from the accounting system to the knowledge base, are one way, so that potentially malicious, vulnerable, and/or exploitable code cannot penetrate the sending system, although a two-way system can be employed.

Because of the expected long length of the customer relationship due to the student education related expenses and loan repayment focus, it is anticipated that customer behavior over this extended period that is collected and analyzed will be a rich source of information for assisting the customer in the building of his or her deposit balances, which is the principal objective. This knowledge base will be integrated as part of a matrix of information and behavior for multiple financial consumer products, namely the education savings and checking accounts, and eventually other accounts and products: money market deposit accounts, credit and/or debit card accounts, consumer loans, automobile loans, and mortgage loans, and thus will have utility for automated managing and marketing of those products.

The knowledge base will additionally preferably have an objective to create predictive profiles of customer behaviors and needs, and will be linked and output to a marketing program that will produce and send specially focused and/or targeted marketing and informational communications and pieces, e.g., hardcopy or digital brochures, notices, cards, digital videos, etc., to the customers, as discussed in more detail below. Some of the communications will be purposed and structured to invite feedback from the customer, which will be inputted to the knowledge base as customer provided data and information. In timed association with the outputting of communications, the pertinent deposit and accounting system accounts will be monitored for responsive behavioral changes, which can provide an indication of effectiveness of the communications, progress of behaviors toward goals, and the knowledge base will automatically adapt the customer profile and behaviors. Thus there will be feedback to the system in the form of new customer accounts and products, customer supplied information, as well as observed customer behaviors. Essentially the same communications can be sent associated with the BankPay brand and without it to enable comparing effectiveness for a particular customer or customer group.

Representative account and customer inputs to the knowledge base can include, but are not limited to: account metrics, namely, velocity and rate of deposit balance change (both increase and decrease); institution contribution metrics, balances, etc.; student customer contributions; donor contribution metrics including frequency and amounts of episodic and continuing donations; account metrics, including charges and fees, interest payments, etc.

Other inputs to the knowledge base will include general market conditions, interest rates, including historical, current, forecasted; and institution metrics including general or categorized customer account trends, institutional balance sheet information, objectives, etc.

### Operational Flow

### (Steps not Necessarily in Order Presented)

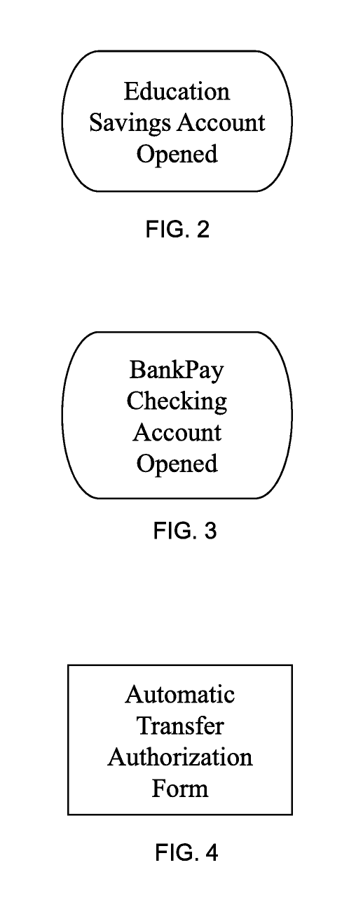

FIG. 2: A customer opens an Educational Savings account by visiting a retail branch location or by going online to the financial institution's website and completing the necessary deposit account opening information.

FIG. 3: The customer opens a BankPay Checking account (this is an adult donor account) by visiting a retail branch or by going on-line to the financial institution's website and completing the necessary deposit account opening information.

FIG. 4: The customer completes an Automatic Transfer Authorization form by visiting a retail branch location or by going online to the financial institution's website and completing the form. The form will specify the account numbers for the Education Savings account and the BankPay Checking account or any adult's checking or savings account (these latter two accounts also referred to herein as “Adult Donor Account” or “Adult Account”). In addition, it will specify the date a transfer is to be made each month or other period on a recurring basis, and the dollar amount of the reoccurring transfer from the BankPay Checking account or Adult Account to the Education Savings account. The minimum transfer amount will be set, e.g., $25.00.

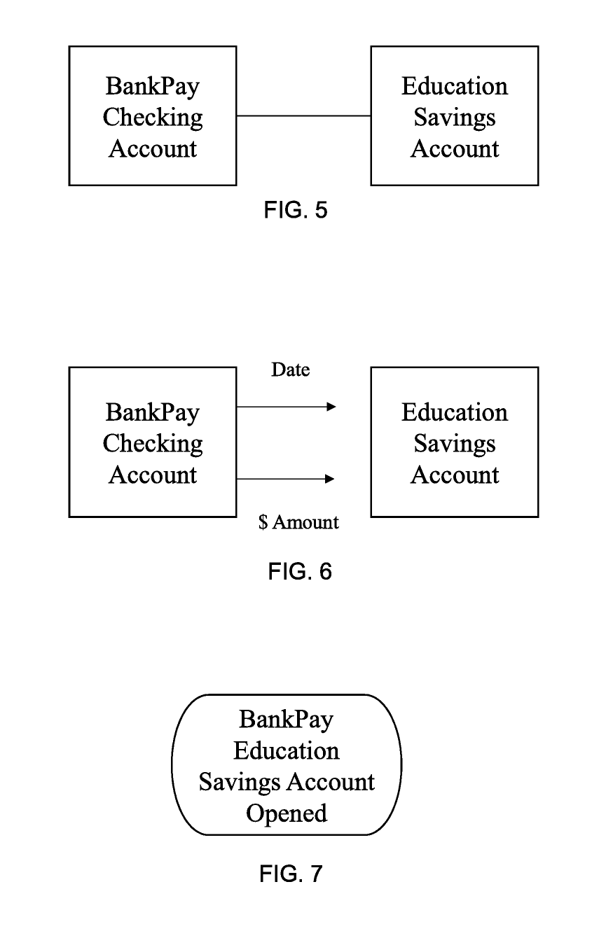

FIG. 5: The financial institution codes the deposit transaction system to link the BankPay Checking account or Adult Donor Account to the Education Savings account.

FIG. 6: The financial institution codes the deposit transaction system with the dollar amount and date for the automatic recurring transfer from the BankPay Checking account or Adult Account to the Education Savings account.

FIG. 7: The financial institution opens a BankPay Education Savings account on the deposit system in the name of the primary account holder on the Education Savings account.

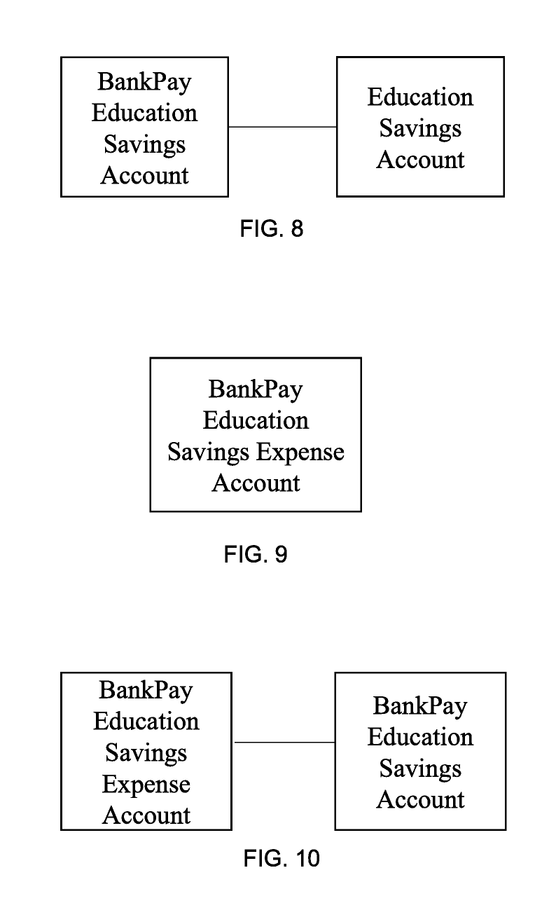

FIG. 8: The financial institution codes the deposit transaction system to link the BankPay Education Savings account to the Education Savings account. The deposit transaction system will be coded to only permit interest transfers which are originated by the financial institution from the BankPay Education Savings Account to the Education Savings account.

FIG. 9: The financial institution creates a BankPay Education Savings expense account on its general ledger chart of accounts within the accounting program.

FIG. 10: The financial institution creates an interface on the deposit transaction and accounting systems between the BankPay Education Saving expense account and the BankPay Education Savings account.

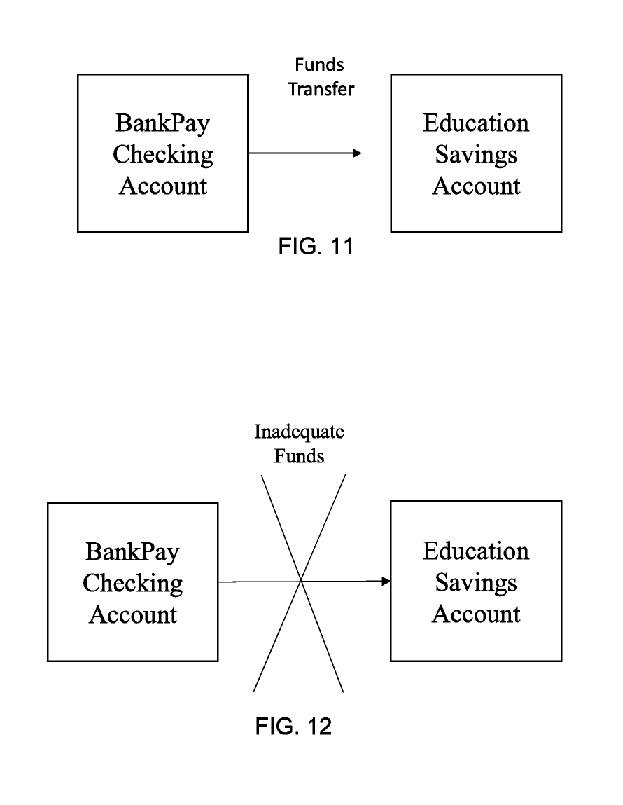

FIG. 11: Based on the date and the dollar amount of the transfer specified by the customer on the Automatic Transfer Authorization form, funds are transferred as designated, e.g., once each month, from the BankPay Checking account or Adult Account to the Education Savings account. The minimum transfer, for instance, will be $25.00.

FIG. 12: The deposit transaction system will be coded not to make the transfer from the BankPay Checking account or Adult Account to the Education Savings account if inadequate funds are available to make the full amount of the authorized transfer.

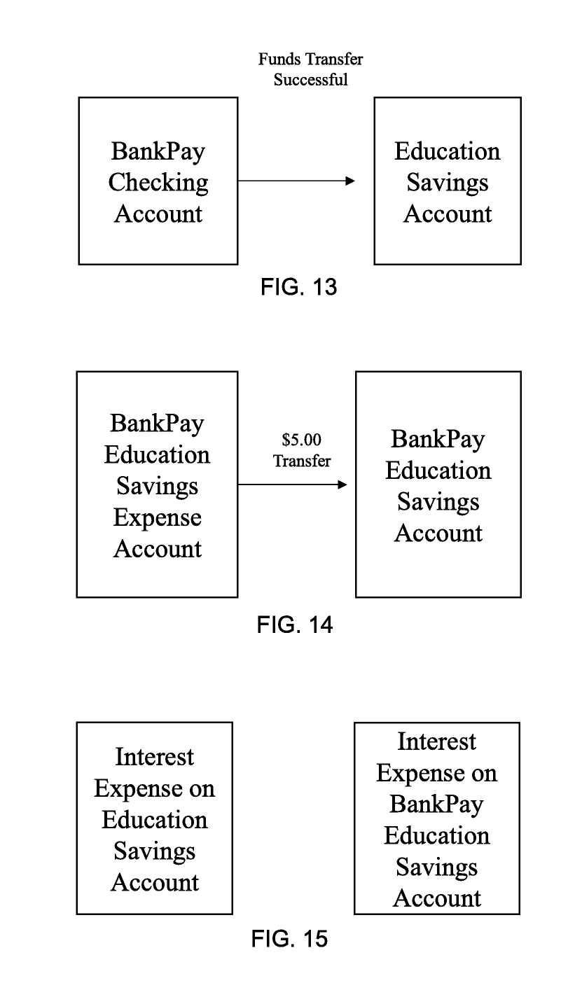

FIG. 13: The deposit transaction system will be coded to automatically verify that the authorized transfer has been made.

FIG. 14: The deposit transaction and accounting systems will be coded to automatically debit, e.g., $5.00, from the BankPay Education Savings expense account and to credit the customer's BankPay Education Savings account.

FIG. 15: The financial institution creates an Interest Expense on the Education Savings account and an Interest Expense on the BankPay Education Savings account.

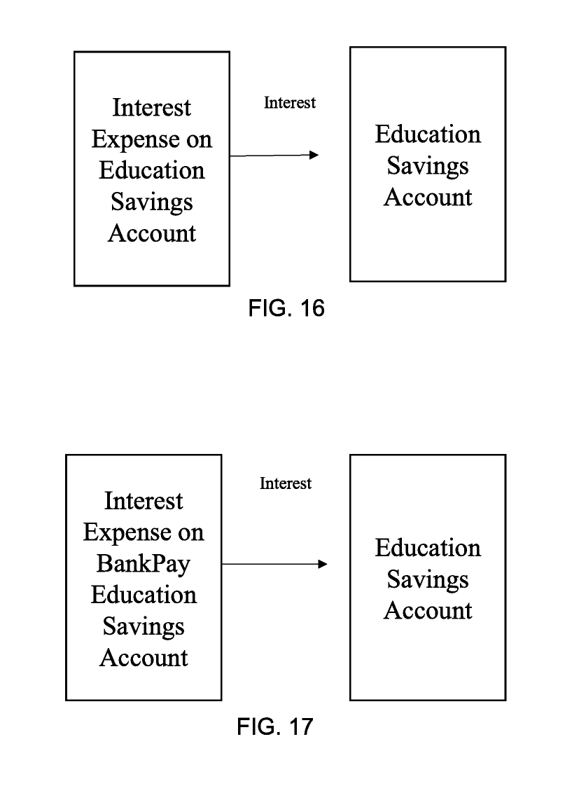

FIG. 16: The accounting system will be coded to automatically pay on a recurring basis interest on the Education Savings account at the end of a designated period, e.g., each calendar quarter. The deposit transaction system will be coded to automatically debit an Interest Expense on Education Savings expense account and credit the customer's Education Saving account for the amount of interest earned.

FIG. 17: The deposit transaction system will be coded to automatically pay on a recurring basis interest on the BankPay Education Savings account at the end of a designated period, e.g., each calendar quarter. The accounting system will be coded to automatically debit an Interest Expense on BankPay Education Savings expense account and the deposit transaction account will credit the customer's Education Savings account for the amount of interest earned on the BankPay Education Savings account.

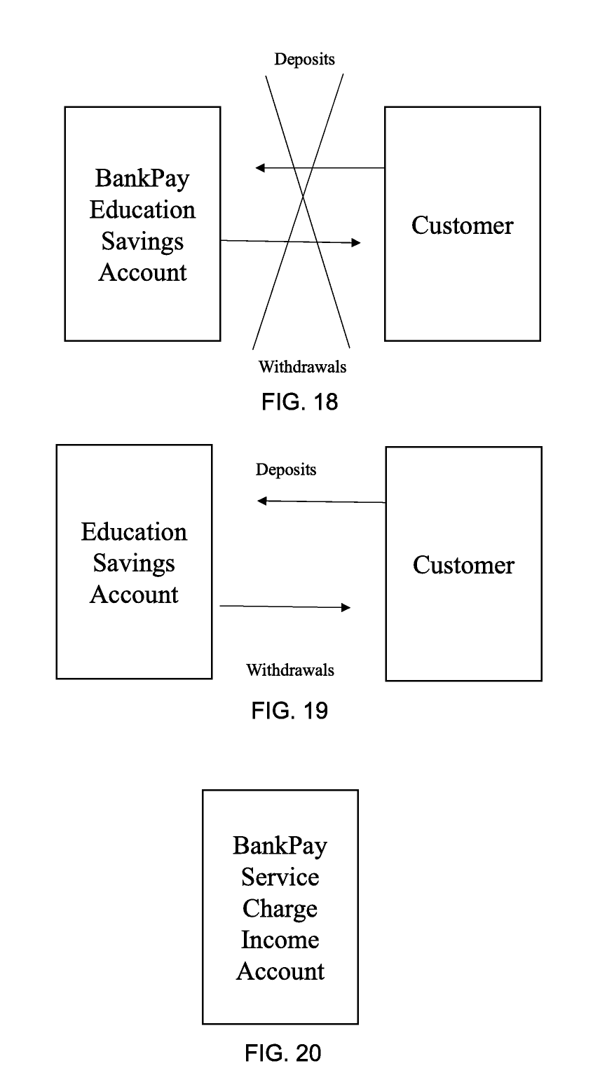

FIG. 18: The deposit transaction system will be coded to automatically prohibit any customer to make any manual or automated deposits to or any manual or automated withdrawals from the BankPay Education Savings account.

FIG. 19: The deposit transaction system will be coded to automatically permit the primary account holder to make manual or automated withdrawals from the Education Savings account and to permit any customer to make automated deposits to that account.

FIG. 20: The financial institution in its accounting system creates a BankPay Service Charge income account on its general ledger chart of accounts.

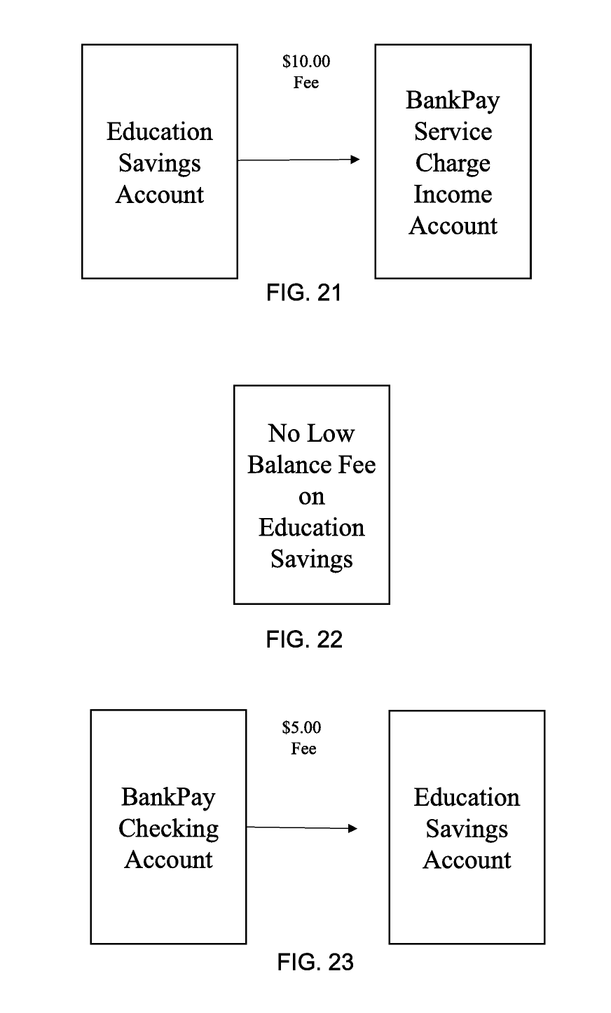

FIG. 21: The deposit transaction system will be coded to automatically charge a fee, e.g., $10, for each transfer out of or withdrawal from an Education Savings account over one total transfer out or withdrawal per month. This account is intended to be used as a savings account and not a transaction account. The $10 fee will be credited to the BankPay Service Charge income account.

FIG. 22: The data processing system will be coded to automatically not charge any minimum balance or low balance fee on the Education Savings account. The rationale is that the financial institution does not desire to charge a fee when an Education Savings account periodically has a low balance.

FIG. 23: The deposit transaction system will be coded to automatically charge a low balance fee, e.g., $5.00, per month if the BankPay Checking account falls below $100 on any day during the monthly statement cycle. The deposit transaction system will be coded to automatically credit the $5.00 monthly low balance fee charged on the BankPay Checking account to the customer's linked Education Savings account. The rationale here is that the financial institution does not desire to profit when a BankPay Checking account periodically has a low balance.

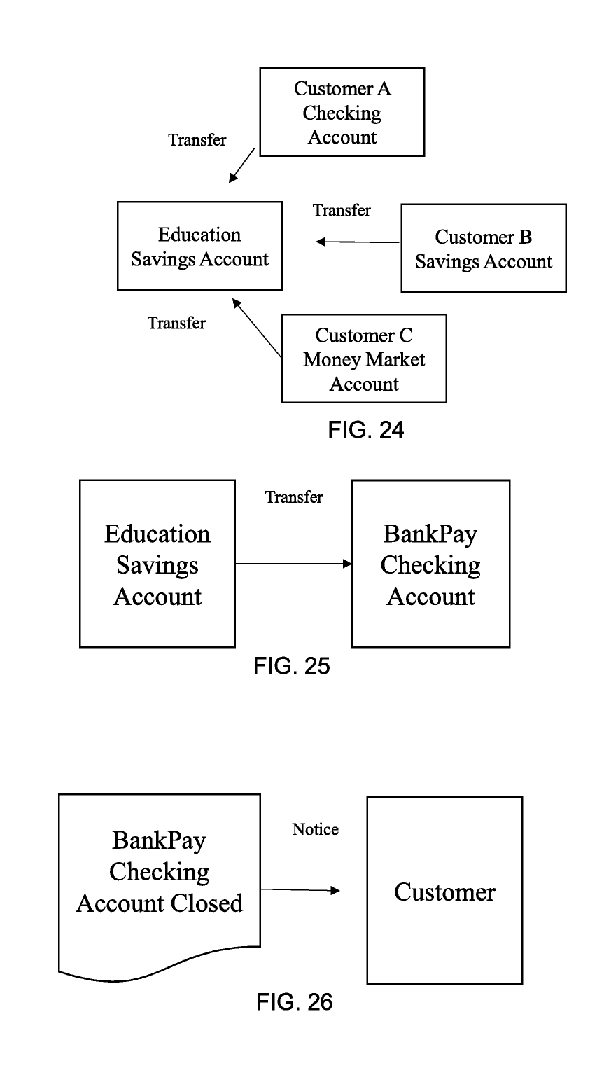

FIG. 24: The deposit transaction system will be coded to permit multiple checking and savings accounts within the same financial institution to be linked to transfer funds to the customer's Education Savings account. This will permit donors, e.g., parent, grandparents, other relatives, friends, employers, potential employers, etc., to assist with paying for college and trade school expenses.

FIG. 25: The deposit transaction system will be coded to only permit funds to be transferred out of the Education Savings account to the customer's linked BankPay Checking account. When the customer wants to make a payment for education related expenses or on a student loan(s), they can transfer the funds from their Education Savings account to their BankPay Checking account and make the payment(s).

FIG. 26: The deposit transaction system will be coded to automatically send the customer a reminder notice if the BankPay Checking account or Adult Account is closed or has a zero or negative balance. The BankPay Checking account or Adult Donor Account must be open and maintain a positive balance as a requirement for the financial institution to maintain the BankPay Education Savings account for the customer.

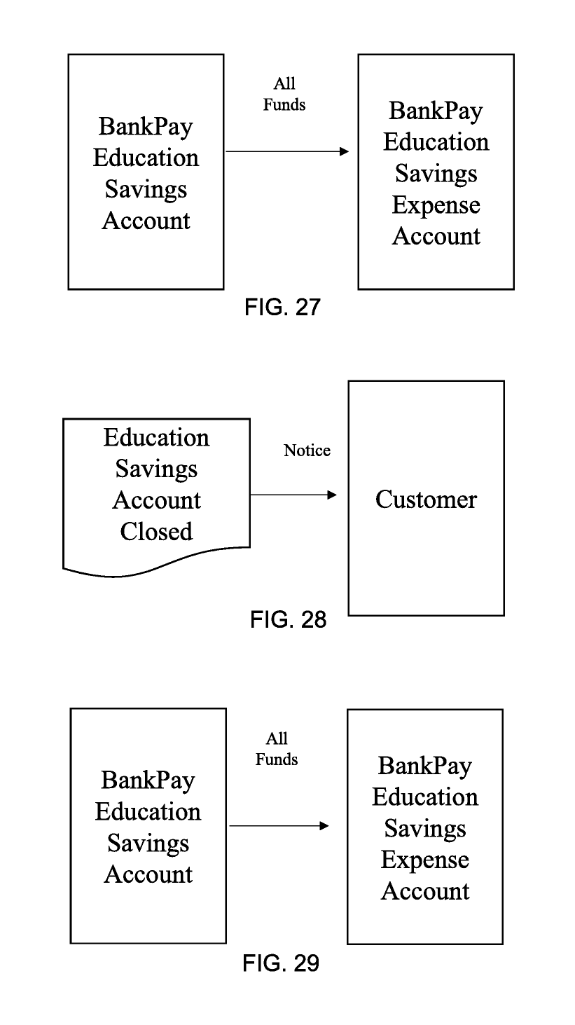

FIG. 27: If the BankPay Checking account or Adult Donor Account is closed or has a zero or negative balance for 30 days or more, and the notifications have been sent, the BankPay Education Savings account will be closed. The funds will be debited from BankPay Education Savings account and will be credited to the BankPay Education Savings expense account.

FIG. 28: The deposit transaction system will be coded so that a reminder notice is issued to the customer if the Education Savings account is closed or has a zero or negative balance. The Education Savings account must be open and maintain a positive balance as a requirement for the financial institution to maintain the BankPay Education Savings account for the customer.

FIG. 29: If the Education Savings account is closed or has a zero or negative balance for 30 days or more, the BankPay Education Savings account will be closed. The funds will be debited from the BankPay Education Savings account and will be credited to the BankPay Education Savings expense account.

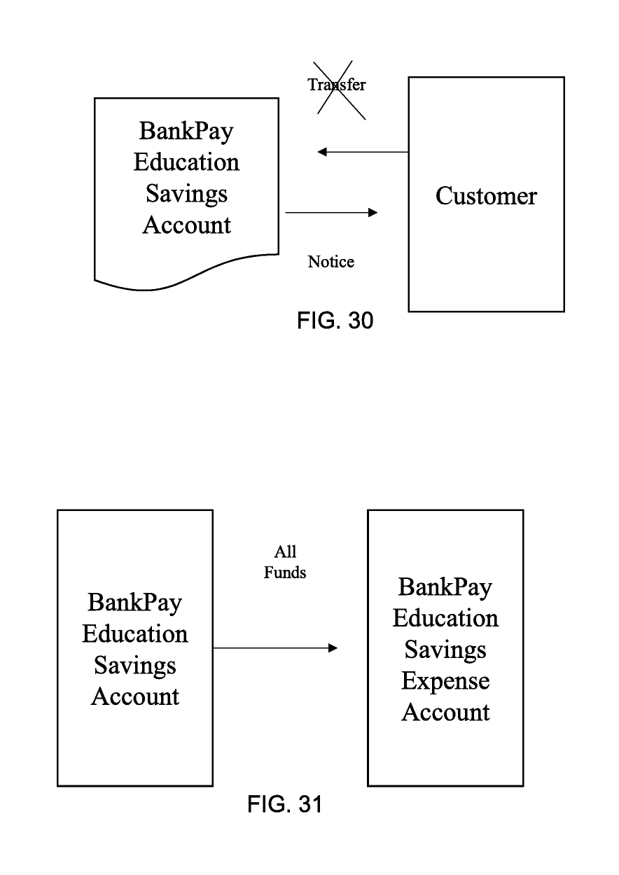

FIG. 30: The deposit transaction system will be coded to send a reminder notice to the customer if the authorized monthly automatic transfer from the BankPay Checking account or Adult Account to the Education Savings account does not occur. This could result from the customer discontinuing the automatic transfer authorization or because inadequate funds were available in the BankPay Checking account or Adult Account to permit the authorized transfer to be made.

FIG. 31: If the automatic transfer from the BankPay Checking account or Adult Donor Account to the Education Savings account is not reinstated within 30 days of the original specified transfer date, the BankPay Education Savings account will be closed. The funds will be debited from the BankPay Education Savings account and credited to the BankPay Education Savings expense account.

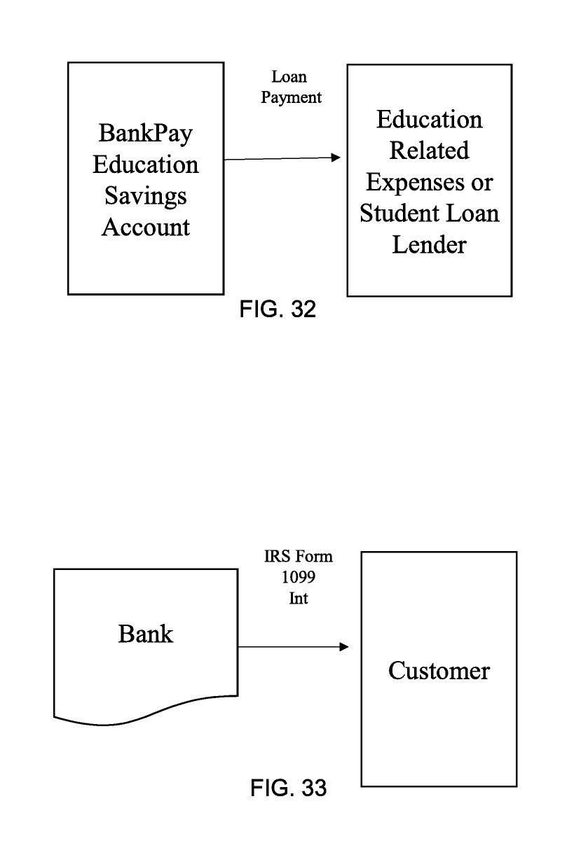

FIG. 32: When the financial institution makes a payment on the customer's education related expenses or student loan, the BankPay Education Savings account will be debited for the amount of the payment and the funds will be sent by the financial institution to the education institution or lender. The customer must present the financial institution with a current education related or loan statement. Rules can be established to define limitations on disbursements. For instance, the customer can be only permitted to request one payment every twelve months from the BankPay Education Savings account. As another rule, the payment may be for any or all of the funds in the BankPay Education Savings account.

FIG. 33: When the financial institution makes the education related expense or student loan payment, the data processing system will be coded to generate an IRS Form 1099 INT to the customer for the amount of the payment. Education related expenses and loans from the U.S. Government Student Loan Program, banks, colleges, universities, accredited trade schools and accredited technical institutions will qualify for payments from the BankPay Education Savings account.

If a customer with a BankPay Education Savings account reaches a designated age, as a non-limiting example, 65 years, and has never presented the financial institution with an education related or loan statement with an outstanding balance, then the customer may request that the funds in their account be used to pay the educational expenses for a relative or friend of the customer.

### Communication/Marketing Interfaces

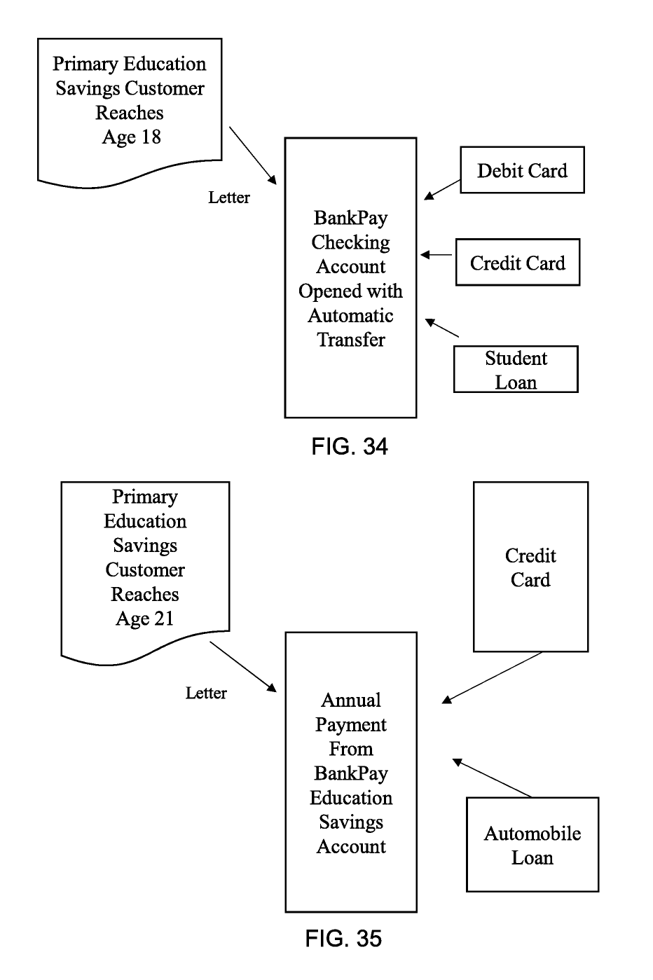

FIG. 34: When the date of birth of the primary Education Saving customer in the knowledge base of the data processing system indicates that the customer has reached the age of 18, a communication, e.g., letter, will automatically be sent to the customer asking them to open a BankPay Checking account and to authorize the required monthly transfer from their BankPay Checking account to their Education Savings account. The marketing information that is sent with this communication can also promote other products, as a non-limiting example, the financial institution's debit card, credit card, student loan products, etc.

FIG. 35: When the date of birth of the primary Education Savings customer in the data processing system indicates that the customer has reached the age of 21, a notice will automatically be sent to the customer to remind them of the annual payment that may be made by the financial institution from their BankPay Education Savings account to pay on their education related expenses or student loan. The marketing information that is sent with this notice will promote the financial institution's credit card and automobile loan products. However, this additional marketing information may not be sent if the data processing system indicates that the customer already has the financial institution's credit card, an existing automobile loan, or customer deposit balance total, credit card balance total, other debt, credit score, etc., exceed individual limits or a collective limit.

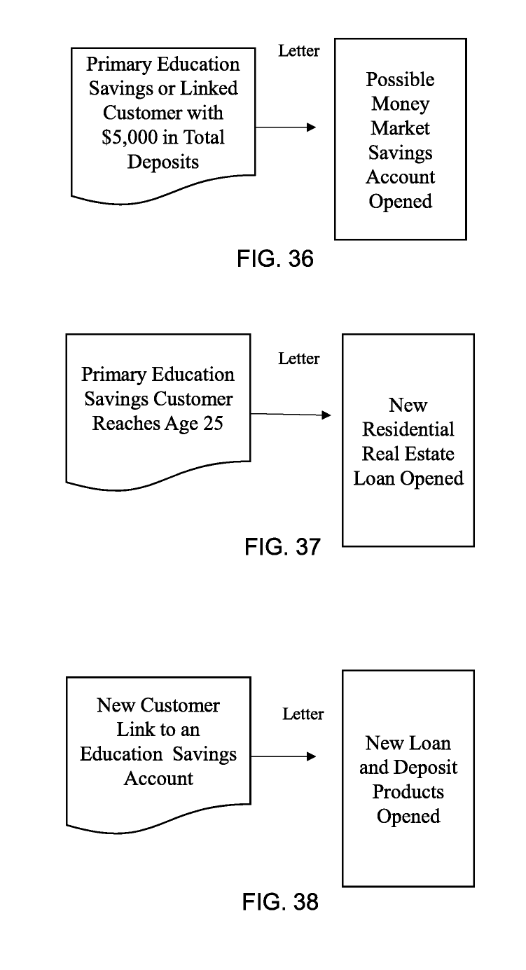

FIG. 36: When the primary Education Savings customer or any customer linked to the primary customer's Education Savings account has a total deposit relationship of $5,000 or more the data processing system will automatically send the customer a communication or communications to encourage them to open a new account or accounts, better tailored to their profile, e.g., a money market savings account or the like. However, the communication will not be generated if the data processing system indicates that the customer already has a money market savings account at the financial institution.

FIG. 37: When the primary customer or any customer linked to the primary customer's Education Savings account has reached the age of 25, a communication will automatically be sent to the customer to encourage them to consider a residential real estate product at the financial institution: e.g., a savings plan for a down payment, or a real estate mortgage. This communication will automatically be generated at a set period, e.g., once a year. However, the communication will not be generated if the customer profile in the knowledge base indicates that the customer already has a home loan at the financial institution.

FIG. 38: When the knowledge base indicates that a new relationship has been linked to an Education Savings account, a communication will be automatically sent to the customer that created the new link. This communication will thank the customer for beginning to contribute to the Education Savings account and encourage them to utilize additional services provided by the financial institution. The letter will be customized based on the services the data processing system indicates are not currently being utilized by the customer.

### Accounting Interfaces

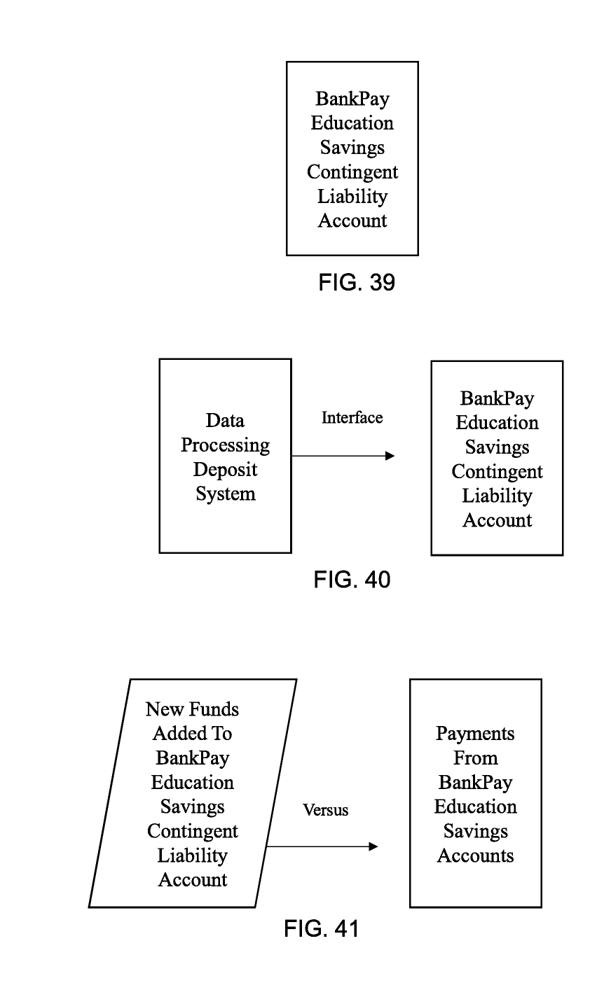

FIG. 39: When a new Education Savings account is opened and the required BankPay Checking or Adult Donor Account has been linked and the automatic monthly transfer established, the financial institution may need to create a BankPay Education Savings Contingent Liability account on its balance sheet.

FIG. 40: Each month, the data processing system will generate a report from the deposit account system of the total qualifying Education Savings accounts and can interface the appropriate credit to the BankPay Education Savings Contingent Liability account.

FIG. 41: Based on the historical data that is collected within the data processing system and the reports that are created from the system, the financial institution will be able to determine the average percentage of funds placed in the BankPay Education Savings Contingent Liability account versus the actual dollar amount of monthly payments made from the total BankPay Education Savings accounts when payments are made for education related expenses or student loans.

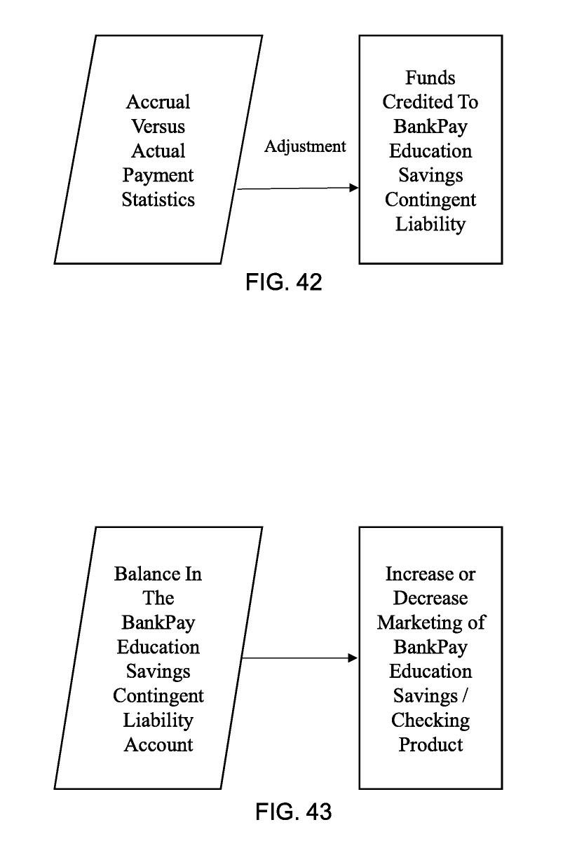

FIG. 42: These accrual versus actual payment statistics can be used by the financial institution on a monthly basis to adjust the dollar amount of funds credited to the BankPay Education Savings Contingent Liability account.

FIG. 43: By monitoring the dollar amount of funds in the BankPay Education Savings Contingent Liability account, the financial institution will be able to decide when it is appropriate to increase or decrease the marketing of the BankPay Education Savings/Checking product.

### Summary

The business process involved with the BankPay Education Savings/Checking accounts can help create significant funds to pay for educational expenses. As an example, assume a newborn infant is two months old and receives a social security number. The parent(s) open a joint Education Savings account for the infant. Then the parent(s) link one of their Adult Accounts to the Education Savings account and authorize a transfer of $50 per month to the Education Savings account. The financial institution will open a BankPay Education Savings account and begin to transfer $5.00 per month of the financial institution's funds into the BankPay Education Savings account. Assume there are no withdrawals from either the Education Savings account or the BankPay Education Savings account. When the student graduates at age 22, the BankPay Education Savings account will have a balance of $1,320 and the Education Savings account will have a balance of $13,200 plus the interest that would have been earned on both the BankPay Education Savings account and the Education Savings account.

The BankPay Education Savings/Checking process can be utilized by financial institutions to encourage education, encourage saving for educational expenses, help to pay a customer's educational expenses and improve the culture of the citizens of the United States.

In light of all the foregoing, it should thus be apparent to those skilled in the art that there has been shown and described a system and methods for saving for education related expenses and loan repayment that uses an automated adaptive knowledge base to reinforce positive customer behaviors to build long-term, multi-generational customer relationships. However, it should also be apparent that, within the principles and scope of the invention, many changes are possible and contemplated, including in the details, materials, and arrangements of parts which have been described and illustrated to explain the nature of the invention. Thus, while the foregoing description and discussion addresses certain preferred embodiments or elements of the invention, it should further be understood that concepts of the invention, as based upon the foregoing description and discussion, may be readily incorporated into or employed in other embodiments and constructions without departing from the scope of the invention. Accordingly, the following claims are intended to protect the invention broadly as well as in the specific form shown, and all changes, modifications, variations, and other uses and applications which do not depart from the spirit and scope of the invention are deemed to be covered by the invention, which is limited only by the claims which follow.

What is claimed is:

1. A method for saving for education related expenses and student loan repayment for a student or future student, comprising steps of:
creating a student education savings account for the student or future student within a deposit transaction system of a financial institution, and associating the student education saving account with at least one adult donor account; then
linking the student education savings account to the at least one adult donor account so as to automatically receive funds therefrom on a recurring basis upon occurrence of a first condition set including at least a first predetermined condition within the deposit transaction system comprising at least one of:
a. depositing funds of at least a predetermined first amount into the adult donor account within a predetermined time period;
b. depositing funds of at least a predetermined second amount into the student education savings account within a predetermined time period; and
c. presence of at least a predetermined amount of funds in the adult donor account at a predetermined time;
creating a bankpay education savings account for the student or future student within the deposit transaction system and linking the bankpay education savings account with a financial institution donor account within the deposit transaction system so as to automatically receive funds therefrom on the recurring basis upon occurrence of a second condition set including at least a second predetermined condition within the deposit transaction system comprising at least:
d. a predetermined minimum balance in the at least one adult donor account, or at least one of the adult donor accounts if more than one adult donor account has existed during a previous period; and
allowing withdrawing or transferring of at least a portion of the funds in the student education savings account at any time during the existence of a positive funds balance therein, but allowing withdrawing or transferring of all or a portion of the funds in the bankpay education savings account only for paying an educational expense or expenses, or a student loan expense or expenses, on behalf of the student, upon occurrence of a third condition set comprising at least:
e. the student being of at least a certain age; and
f. presentation of proof of the incurring or existence of the educational expense or expenses or the student loan expense or expenses.

2. The method of claim 1, comprising a step of identifying the funds in the bankpay education savings account as a contingent liability in accounting records of the financial institution until withdrawn or transferred from the bankpay education savings account.

3. The method of claim 1, wherein an amount of the funds automatically received by the bankpay education savings account from the financial institution donor account on the recurring basis comprises a fixed value.

4. The method of claim 1, wherein an amount of the funds automatically received by the bankpay education savings account from the financial institution donor account on the recurring basis comprises a percentage of a value.

5. The method of claim 1, wherein an amount of the funds automatically received by the bankpay education savings account from the financial institution donor account on the recurring basis is a function of an amount deposited or existing in the at least one donor account.

6. The method of claim 1, comprising a further step of linking the bankpay education savings account to the student education savings account within the deposit transaction system so that the student education savings account will automatically receive interest or a portion of interest earned by the bankpay education savings account on the recurring basis upon occurrence of the second condition set.

7. The method of claim 1, wherein the step of allowing withdrawing or transferring of at least a portion of the funds in the student education savings account at any time during the existence of a positive funds balance therein comprises transferring the at least a portion of the funds in the student education savings account to an education expense checking account.

8. The method of claim 1, comprising a step wherein the financial institution creates a bankpay education savings expense account within an accounting program and to which interest accrued on a balance in the student education savings account will be debited when the interest accrued is credited to the student education savings account.

9. The method of claim 1, comprising a step of creating a knowledge base for the student or future student, comprising a profile of the student or future student and data representing behavior of the student education savings account, updating the profile and data representing the behavior of the student education savings account on a continuing or periodic basis and customizing marketing messages to be sent to the student as a function of the updated profile and data representing the behavior of the student education savings account on a continuing or periodic basis.

10. The method of claim 1, comprising a step of creating a knowledge base for the adult donor or donors comprising data representing behavior of the adult donor account or accounts, updating the profile and data representing the behavior of the adult donor account or accounts on a continuing or periodic basis and customizing marketing messages to be sent to the adult donor or donors as a function of the updated profile and data representing the behavior of the adult donor account or accounts on a continuing or periodic basis.

11. The method of claim 1, comprising a step wherein the financial institution creates a bankpay education savings expense account within an accounting program and to which fees to be credited to the student education savings account will be debited.

12. The method of claim 1, comprising a step wherein the financial institution creates a bankpay education savings expense account within an accounting program and to which fees to be credited to the student education savings account will be debited.
